(19) United States
(12) Patent Application Publication
(10) Pub. No.: US 2011/0048265 A1
(43) Pub. Date: Mar. 3, 2011

(54) METHOD FOR MAKING A LITHOGRAPHIC PRINTING PLATE SUPPORT

(75) Inventors: Paola Campestrini, Antwerpen (BE); Dirk Faes, Herselt (BE)

(73) Assignee: Agfa Graphics NV, Mortsel (BE)

(21) Appl. No.: 12/528,586

(22) PCT Filed: Mar. 7, 2008
(86) PCT No.: PCT/EP2008/052785

§ 371 Date: Nov. 15, 2010

Related U.S. Application Data
(60) Provisional application No. 60/895,764, filed on Mar. 20, 2007.

(30) Foreign Application Priority Data
Mar. 19, 2007 (EP) 07104382.2

(51) Int. Cl. B41N 3/08

(52) U.S. Cl. 101/463.1

(57) ABSTRACT

A method for making a lithographic aluminum printing plate support comprising the steps of (i) graining said support by applying a charge density x; (ii) desmutting the grained support; (iii) graining the desmutted support by applying a charge density y; (iv) anodizing the support; characterized in that during each graining step a current density varying between 80 and 250 A/dm2 is applied and that the ratio x/x+y varies between 0.3 and 0.7.

### FIELD OF THE INVENTION

The present invention relates to a method for making a lithographic printing plate support and to a method for making a heat- and/or light sensitive, lithographic printing plate comprising said support.

### BACKGROUND OF THE INVENTION

Lithographic printing presses use a so-called printing master such as a printing plate which is mounted on a cylinder of the printing press. The master carries a lithographic image on its surface and a print is obtained by applying ink to said image and then transferring the ink from the master onto a receiver material, which is typically paper. In conventional, so-called “wet” lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the image-wise exposure and processing of an imaging material called plate precursor. In addition to the well-known photosensitive, so-called pre-sensitized plates, which are suitable for UV contact exposure through a film mask, also heat-sensitive printing plate precursors have become very popular in the late 1990s. Such thermal materials offer the advantage of daylight stability and are especially used in the so-called computer-to-plate method wherein the plate precursor is directly exposed, i.e. without the use of a film mask. The material is exposed to heat or to infrared light and the generated heat triggers a (physico-)chemical process, such as ablation, polymerization, insolubilization by cross linking of a polymer, heat-induced solubilization, or by particle coagulation of a thermoplastic polymer latex.

Thermal processes which enable plate making without wet processing are for example based on ablation of one or more layers of the coating. At the exposed areas the surface of an underlying layer is revealed which has a different affinity towards ink or fountain than the surface of the unexposed coating; the image (printing) and non-image or background (non-printing) areas are obtained.

Another type of printing plates based on thermal processes requiring no wet processing step are for example plates based on switching—i.e. plates of which the surface is irreversibly changed from a hydrophilic surface to a hydrophobic surface or vice versa upon exposure to heat and/or light. These so called “switchable polymer systems” are based on different working mechanism such as for example masking/demasking of a polar group or destruction/generation of charge.

The most popular thermal plates form an image by a heat-induced solubility difference in an alkaline developer between exposed and non-exposed areas of the coating. The coating typically comprises an oleophilic binder, e.g. a phenolic resin, of which the rate of dissolution in the developer is either reduced (negative working) or increased (positive working) by the image-wise exposure. During processing, the solubility differential leads to the removal of the non-image (non-printing) areas of the coating, thereby revealing the hydrophilic support, while the image (printing) areas of the coating remain on the support. Typical examples of such plates are described in e.g. EP-A 625728, 823327, 825927, 864420, 894622 and 901902. Negative working embodiments of such thermal materials often require a pre-heat step between exposure and development as described in e.g. EP-A 625,728.

Negative working plate precursors which do not require a pre-heat step may contain an image-recording layer that works by heat-induced particle coalescence of a thermoplastic polymer latex, as described in e.g. EP-As 770 494, 770 495, 770 496 and 770 497. These patents disclose a method for making a lithographic printing plate comprising the steps of (1) image-wise exposing an imaging element comprising hydrophobic thermoplastic polymer particles dispersed in a hydrophilic binder and a compound capable of converting light into heat, (2) and developing the image-wise exposed element by applying fountain and/or ink.

U.S. Pat. No. 5,728,503 provides a grained and anodized aluminum support for a light sensitive printing plate having a substantially uniform topography comprising peaks and valleys and surface roughness parameters Ra (0.10-0.5 μm), Rt (0-6 μm), Rp (0-4 μm) and Rz (0-5 μm).

EP 1,400,351 discloses a lithographic printing plate precursor containing an aluminum support and a photosensitive layer containing an alkali-soluble resin and an infrared absorber, wherein the photosensitive layer has a coating weight of 0.5 to 3 g/m² and a thickness distribution with a maximum relative standard deviation of 20%.

WO 02/01291 discloses a lithographic plate comprising on a roughened substrate a substantially conformal radiation-sensitive layer; i.e. the surface of the radiation-sensitive layer has peaks and valleys substantially corresponding to the major peaks and valleys of the microscopic surface of the roughened substrate. Tackiness, block resistance and press durability of the plate are improved.

U.S. Pat. No. 6,912,956 discloses a printing plate material comprising a substrate having a center line average surface roughness Ra of 0.2 to 1.0 μm and an oil-retention volume A2 of 1 to 10, and provided thereon a component layer onto which an image is capable of being recorded by imagewise exposure with an infrared laser.

U.S. Pat. No. 4,721,552 discloses a two steps electrochemical graining treatment of lithographic support. The supports are, after degreasing and desmutting pretreatments, grained by applying 15 to 100 A/dm² to the support in an aqueous acidic solution comprising hydrochloric acid, then the support is etched and desmutted and finally grained in an acidic solution comprising nitric acid at a current density of 15 to 80 A/dm².

In EP 536 531 a method for roughening an aluminium support is disclosed comprising two subsequent electrochemical graining steps followed by a so-called pickling step. When the pickling step is carried out in between the two roughening steps, a poor quality support is obtained.

US 2005/0153242 discloses the treatment of an aluminium support comprising an electrochemically surface-roughening step comprising two stages in which the current density D1 applied in the first stage ranges between 40 and 100 A/dm² and the total applied charge density Q1+Q2 ranges from 600 to 1500 C/dm².

EP 437 761 provides a process for roughening aluminium printing plate supports including a primary roughening stage comprising immersing the support in an acidic electrolyte solution comprising sulphate and chloride ions and a secondary roughening stage in an acidic solution comprising aluminium ions.

US 2006/0032760 describes a surface treatment of a lithographic support comprising two electrolytic graining steps which are preferably carried out by applying a current density ranging between 10 and 300 C/dm² in order to obtain excellent scumming resistance. In US 2006/0040212 a two steps electrochemical graining process is disclosed wherein the first graining step is carried out at a current density ranging between 10 and 100 A/dm² and a charge density ranging between 1 and 1000 C/dm²; and the second step is carried out by applying a charge density ranging between 20 and 100 C/dm².

U.S. Pat. No. 5,141,605 describes the surface treatment of an aluminium support comprising the following steps: (i) an electrochemical graining step, (ii) an etching step selected from immersing the support in a sulphuric acid solution at a high temperature for a long time, immersing the support in caustic soda or electrically polishing the support, (iii) graining the obtained support for a second time.

EP 1 157 854 discloses a presensitized plate having a lithographic support which is subjected to graining, alkali etching and anodizing treatments. The disclosed graining treatment may include two steps, a first electrochemical graining step in an aqueous solution based on hydrochloric acid or nitric acid by using a current density ranging between 20 to 200 A/dm² and a quantity of electricity ranging between 10 to 1000 C/dm², and a second electrochemical graining step. Between both graining steps, an etching and a desmut step are carried out.

In general, the use of aluminum substrates as supports for lithographic printing plates, requires that they undergo several treatments such as for example graining and anodizing. Lithographic supports are roughened or grained to improve both the adhesion of the image areas and the wetting characteristics of the non-image areas without reducing the clean out behaviour—i.e. removal of coating residues at non-image areas—of the support. The type of pits obtained after a graining step, especially their size and distribution over the surface, highly influence the lithographic behaviour of the related printing plate. It is believed that deep and/or large pits are responsible for the occurrence of coating residues at non image areas (bad clean out behaviour) and/or a less effective hardening of the coating for negative-working printing plates (reduction of run length). On the other hand, too small pits may impede the water holding properties and may adverse proper adhesion of the coating layer. In addition, the amount of ungrained areas or so-called plateaux should be limited as such areas may result in an increased coating and/or substrate wear and in a reduction of the water holding properties.

In conclusion, an aluminium support for a printing plate should have a surface characterized by uniform and small pits evenly distributed over said surface in order to provide a good balance between adhesion properties of the coating at the image areas (i.e. print durability) and water retention and clean out behavior at the non-image areas.

### SUMMARY OF THE INVENTION

It is an object of the present invention to provide a method for making a lithographic aluminum printing plate support that has a surface comprising pits which are evenly distibuted over the surface and are uniform and small in size.

This object is realized by the method of claim 1; i.e. a method for making an aluminum lithographic printing plate support which comprises the steps of:
(i) graining said support by applying a charge density x
(ii) desmutting the grained support;
(iii) graining the desmutted support by applying a charge density y;
(iv) anodizing the support;
   characterized in that during each graining step a current density varying between 80 and 250 A/dm² is applied and that the ratio x/x+y varies between 0.3 and 0.7.

A detailed study of the microstructure of an aluminum support obtained according to the method of the present invention surprisingly showed that the surface of said support comprises evenly distributed pits which are uniform and small in size. The detailed study was carried out using a recently developed threshold procedure described below.

It is a further object to provide a method for making a lithographic printing plate that, after applying a heat- and/or light-sensitive coating, exposing and optional developing said printing plate, does not show the occurrence of coating residues, has a good water retention at the non-image areas and has a high print durability.

This object is realized by the method of claim 10; i.e. a method for making a lithographic printing plate which comprises the steps of: (i) providing a printing plate precursor comprising the support as described above and a heat-sensitive coating applied thereon; (ii) exposing the printing plate precursor to heat and/or light and (iii) optionally processing said exposed precursor with an aqueous liquid.

Other features, elements, steps, characteristics and advantages of the present invention will become more apparent from the following detailed description of preferred embodiments of the present invention.

### BRIEF DESCRIPTION OF THE DRAWINGS

FIG. 1 shows a two-dimensional surface profile.

FIG. 2 shows a bearing ratio curve of a surface profile.

FIG. 3 shows the Rₖ-construction drawn on the bearing ratio curve.

FIG. 4 shows an interferometer image thresholded at height D defined in the Rₖ-construction, and wherein the gray-scale relates to the depth of the pits and their distribution throughout the cross-section.

FIG. 5 shows a graph illustrating the newly developed threshold procedure for determination of the pit size distribution.

### DETAILED DESCRIPTION OF THE INVENTION

The lithographic printing plate support according to the method of the present invention is an aluminum support. The surface of the aluminum support is grained and anodized aluminum. The support may be a sheet-like material such as a plate or it may be a cylindrical element such as a sleeve which can be slid around a print cylinder of a printing press.

Graining of an aluminum support involves an anodically polarised cycle wherein pits are formed followed by a cathodically polarised cycle wherein a so-called smut layer (Al(OH)₃ layer) is build up. It is believed that the smut reduces during its growth the graining efficiency resulting in a less uniform pit formation; i.e. a surface with deeper pits and more plateaux. The final surface morphology is therefore probably determined by the balance between pit formation and smut formation during the graining step. Several graining process parameters may determine this balance; for example the electrolyte composition, the electrolyte temperature, flow and/or concentration of the electrolyte; the charge density (C/dm²); the current density (A/dm²); the voltage (V) and/or the AC-signal frequency. A minimum level of charge density is required to produce a sufficiently grained surface. In the industrial production of printing plate supports, it is an ongoing requirement to produce printing plate supports in shorter time periods. When an aluminum support is grained during a shorter time, as is required in the industry, a higher current density has to be applied in order to obtain the same charge density at the surface and thus the same surface morphology. Indeed, the charge density Q (C/dm²) at time t is the integrated value of the absolute value of the local current density J (A/dm²) at time t:

$$Q ( t ) = {\int }_{0}^{t} \vert J ( τ ) \vert d τ . \qquad Equation 1$$

However, as is known in the art, applying a higher current density to the support, results in a worse surface morphology; i.e. deeper pits and the occurrence of more plateaux (ungrained areas).

A detailed study of the microstructure of an aluminum support obtained according to the method of the present invention surprisingly showed that the surface of said support comprises evenly distributed pits which are uniform and small in size. This improved surface morphology is obtained even at high current densities and high line speeds. The method of the current invention involves at least two graining steps and a desmutting step between said graining steps; and the first graining step is carried out by applying a charge density x which represents 30 to 70% of the total applied charge density in both steps. Thus, the first graining step is carried out by applying a charge density x, the second graining step is carried out by applying a charge density y and the ratio x/x+y varies between 0.3 and 0.7. The current density in each graining step independently ranges between 80 A/dm² and 250 A/dm², more preferably the current density in each graining step independently ranges between 90 A/dm² and 220 A/dm². The surface of a printing plate treated following the method of the current invention, has evenly distributed small pits characterized by a mean pit depth equal or less than 1.6 μm, more preferably equal to or lower than 1.55 μm and most preferably equal to or lower than 1.5 μm. The variation in size of these pits is small, i.e. maximum 0.45 μm, indicating that the pits are uniform in size. This is of high interest in industrial production lines as shorter graining times result in higher line speeds. The mean pit depth and the variation in pit depth over the surface are defined according to a recently developed threshold procedure and is described in detail below. The mean pit depth gives an improved indication of surface roughness compared to Ra values (arithmetical mean center-line roughness, see ISO 4287/1 or DIN 4762) which are in general employed in the prior art to indicate surface roughness, because Ra values give average values of peaks and valleys present on the surface of a support and the presence of deep and/or large pits do not substantially influence the Ra value. The variation in pit depth over the surface gives an indication of the degree of distribution of the pits over the surface.

The charge density x preferably varies between 80 and 2000 C/dm², more preferably between 100 and 1500 C/dm² and most preferably between 150 and 1250 C/dm². Each graining step is preferably independently carried out for a period ranging from 1 to 15 s, more preferably from 1.5 to 13 s and most preferably from 2 to 10 s.

The graining steps may be carried out in an aqueous electrolyte solution comprising independently preferably at least one of the following chemicals: HNO₃, CH₃COOH, HCl and/or H₃PO₄. The composition of the electrolyte solution applied in each graining step may have the same or a different chemical composition. In a preferred embodiment, the two graining steps are each carried out in an electrolyte solution containing HCl. The electrolyte solution may contain other chemicals such as surfactants or salts (e.g. Al³⁺ or SO₄²⁻ salts). Additives such as benzoic acid derivatives or sulphonic acid derivatives as disclosed in unpublished patent application EP 06110469.1 filed on Feb. 28, 2006 may also be added to the electrolyte solution. The concentration of HCl, HNO₃, CH₃COOH and/or H₃PO₄ in the electrolyte solution preferably varies between 1 g/l and 50 g/l; more preferably between 5 g/l and 30 g/l; most preferably between 7 g/l and 20 g/l. The electrolyte temperature may be at any suitable temperature but preferably ranges from 20° C. to 55° C., more preferably from 30° C. to 45° C. Graining may be carried out using an alternating current such as a sine wave current, a trapezoidal wave current, or a rectangular wave at a frequency ranging preferably between 10 and 200 Hz, more prefarably between 20 and 150 Hz and most preferably between 30 and 120 Hz. The applied voltage ranges for example from 5 V to 50 V, preferably from 20 V to 40 V.

After the first graining step, the smut layer build up during said graining step is for the most part removed by means of a desmutting step. In a preferred embodiment, the smut layer is completely removed during the desmutting step. The desmutting step can be carried out in an aqueous alkaline desmut solution comprising for example NaOH at a concentration varying between 1 g/l and 15 g/l, preferably between 2 and 10 g/l most preferably between 3 and 8 g/l; or in an aqueous is acidic desmut solution comprising for example H₃PO₄ and/or H₂SO₄ at a concentration varying between 10 and 600 g/l, preferably between 20 and 400 g/l, most preferably between 40 and 300 g/l. Besides chemical composition and concentration of the desmut solution, also its temperature and reaction time influence the desmut step. The reaction time preferably varies between 0.5 and 30 s, more preferably between 1 and 15 s and most preferably between 1.5 and 10 s and the temperature varies preferably between 20 and 95° C., more preferably between 25 and 85° C. In a particularly preferred embodiment, the desmut step is carried out in an acidic solution comprising H₂SO₄ at a concentration varying between 80 and 200 g/l at a temperature varying between 25 and 85° C. and for a time period of 1.5 to 10 s. The desmutting step is usually carried out by dipping or spraying the support with the desmut solution.

After the graining steps and the desmutting step according to the method of the present invention, a final desmutting step may be carried out. The composition and the temperature of the desmut solution and the reaction conditions of this desmut step are as described above.

The aluminum is anodized by means of anodizing techniques employing sulphuric acid and/or a sulphuric acid/phosphoric acid mixture. By anodising the aluminium support, its abrasion resistance and hydrophilic nature are improved. The microstructure as well as the thickness of the Al₂O₃ layer are determined by the anodising step; the anodic weight (g/m² Al₂O₃ formed on the aluminium surface) generally varies between 1 and 8 g/m². Methods of anodizing are known in the art and are for example disclosed in GB 2,088,901.

The grained and anodized aluminum substrate of the present invention may be post-treated to further improve the hydrophilic properties of its surface. For example, the aluminum oxide surface may be silicated by treatment with a sodium silicate solution at elevated temperature, e.g. 95° C. Alternatively, a phosphate treatment may be applied which involves treating the aluminum oxide surface with a phosphate solution that may further contain an inorganic fluoride. Further, the aluminum oxide surface may be rinsed with an organic acid and/or salt thereof, e.g. carboxylic acids, hydrocarboxylic acids, sulphonic acids or phosphonic acids, or their salts, e.g. succinates, phosphates, phosphonates, sulphates, and sulphonates. A citric acid or citrate solution is preferred. This treatment may be carried out at room temperature or may be carried out at a slightly elevated temperature of about 30° C. to 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulphonic acid, polyvinylbenzenesulphonic acid, sulfuric acid esters of polyvinyl alcohol, and acetals of polyvinyl alcohols formed by reaction with a sulfonated aliphatic aldehyde. It is further evident that one or more of these post treatments may be carried out alone or in combination. More detailed descriptions of these treatments are given in GB 1084070, DE 4423140, DE 4417907, EP 659909, EP 537633, DE 4001466, EP A 292801, EP A 291760 and U.S. Pat. No. 4,458,005.

The graining morphology of the surface in terms of the mean pit depth was determined according to the following recently developed threshold procedure.

First, three dimensional images are recorded of the substrate which characterize the graining morphology surface or the roughness properties of the surface of said substrate. From these images several parameters that describe various aspects of the surface-morphology can be calculated. The

Bearing Ratio Analysis technique (see for example Wyko Surface Profilers Technical Reference Manual, September 1999, from Veeko, Metrology Group (pages 3-3 to 3-11) or US 2004/0103805), has been used for calculating these parameters. The three dimensional images or surface profiles can be obtained by using a white-light interferometer from Veeco (NT3300, commercially available from Veeco Metology Group, Arizona, USA).

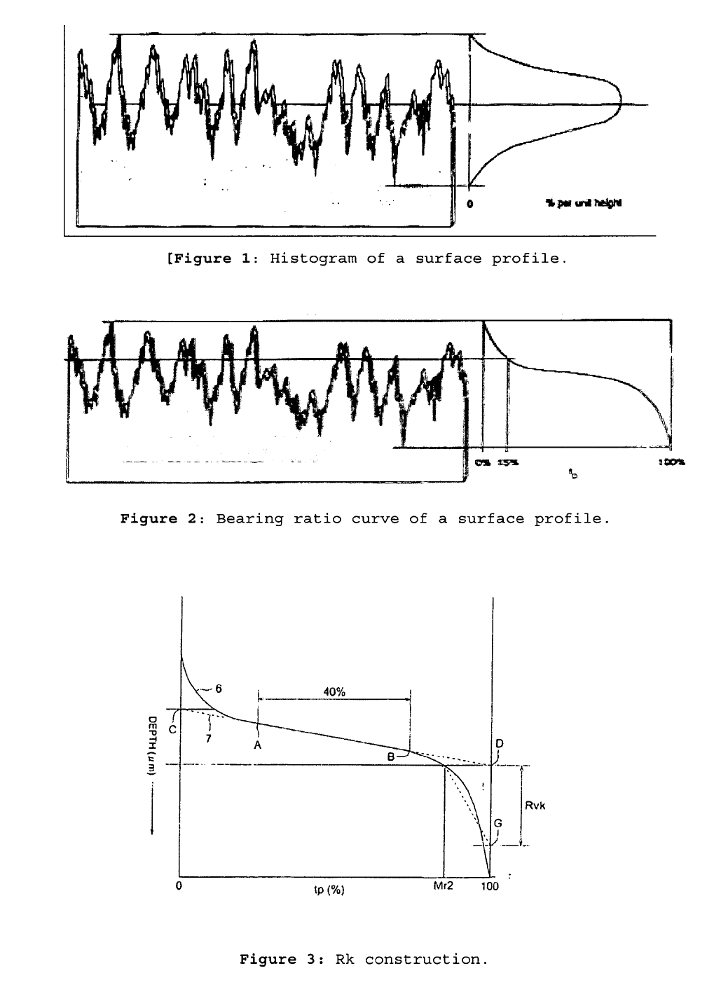

From the obtained surface profile, two curves can be derived: the histogram of the surface profile (FIG. 1) and the bearing ratio curve (FIG. 2). The histogram of the surface profile, also called Amplitude Distribution Function (ADF), gives the probability that the profile of the surface has a certain height z at any xy position. In other words, the ADF gives the probability that a point on the surface profile at a randomly selected position xy, has a height of approximately z. The bearing ratio curve is the mathematical integral of the ADF and each point on the bearing ratio curve has the physical significance of showing what fraction of a profile lies above a certain height. In other words, the bearing ratio curve shows the percentage of intercepted material by a plane parallel to the surface plane, versus the depth of that plane into the surface.

From the bearing ratio curve, parameters describing the surface morphology are defined using the so-called Rk-construction (FIG. 3). These parameters are core roughness depth (Rk), reduced peak height (Rpk), reduced valley depth (Rvk) and valley material component (100%-Mr2) and are defined as follows in the ISO standard 13565-1996:
Core roughness depth (Rₖ): is the vertical height between the left and right intercepts of the line through the ends of the minimum height 40% window.
Reduced peak height (Rₚₖ): is an estimate of the small peaks above the main plateau of the surface.
Reduced valley depth (Rᵥₖ): is an estimate of the depth of the valleys.
Peak material component (Mᵣ₁): is the fraction of the surface that consists of small peaks.
Valley material component (100%-Mᵣ₂): is the fraction of the surface that consists of deeper valleys.

The heights C and D at the surface profile are determined in the Rₖ-construction by identyfying the minimum secant slope. The minimum secant slope is obtained by sliding a 40% window (of the 0 to 100% axis in FIG. 3) across the bearing ratio curve (6). This window intersects the curve at two points, i.e. points A and B and the goal is to find the position where the slope between the two points is minimised. When the minimum slope is found, a line (7) through points A and B is drawn and the intercepts on the ordinates at bearing ratio 0% and 100% yield respectively points C and D.

According to the present invention, a new threshold procedure based on the parameters defined in the Rₖ construction has been defined which enables to evaluate the pit size distribution.

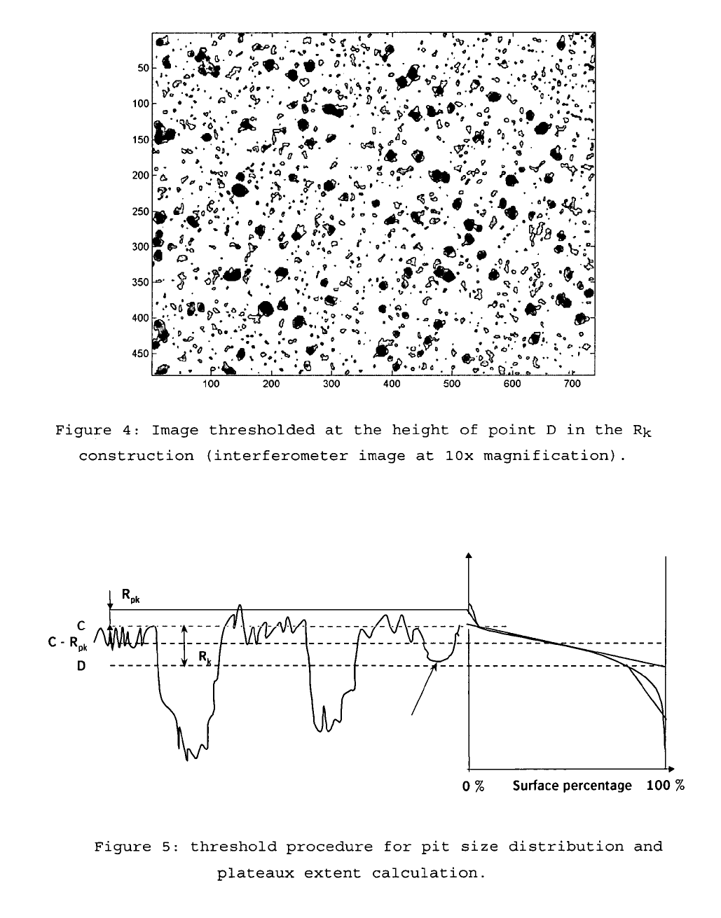

For the evaluation of the pit size distribution, first of all the three dimensional interferometer image is thresholded at height D (FIG. 4). FIG. 4 is in fact a cross-section at height D of the aluminium surface and shows the pits at this height. The gray-scale of FIG. 4 relates to the depth of the pits and their distribution throughout the cross-section. Each pixel has a depth value that enables to create the grey-scale image. The threshold enables to identify and separate objects, i.e. pits. The pits are separated from each other using a convex-components analysis. The area, depth, and volume of each single pit can then be calculated using appropiate software such as Matlab. For example, the is area of a pit is calculated on the tresholded image by multiplying the number of pixels belonging to a pit with the physical area of one pixel. From these values the mean and standard deviation of the pit area, depth and volume at the threshold height can be calculated. The pit depth obtained from this threshold procedure is corrected to the real depth by adding Rₖ (FIG. 5). Similarly, the volume of the pit is also corrected by adding the volume of a cylinder having as area the calculated area of the pit (at level D) and as height Rk (FIG. 5). The pits with a depth lower than Rₖ+Rₚₖ (indicated by the arrow in FIG. 5) are not identified as pits by this image analysis. However, this threshold procedure enables to compare the size distribution of the deep pits of different substrates.

According to the present invention, there is also provided a method for making a lithographic printing plate precursor comprising the steps of providing a support as discussed in detail above, applying a coating solution comprising at least one heat- or light-sensitive imaging layer onto said support and than drying the obtained precursor.

The precursor can be negative or positive working, i.e. can form ink-accepting areas at exposed or at non-exposed areas respectively. Below, suitable examples of heat- and light-sensitive coatings are discussed in detail.

### Heat-Sensitive Printing Plate Precursors.

The imaging mechanism of thermal printing plate precursors can be triggered by direct exposure to heat, e.g. by means of a thermal head, or by the light absorption of one or more compounds in the coating that are capable of converting light, more preferably infrared light, into heat.

A first suitable example of a thermal printing plate precursor is a precursor based on heat-induced coalescence of hydrophobic thermoplastic polymer particles which are preferably dispersed in a hydrophilic binder, as described in e.g. EP 770 494; EP 770 495; EP 770 497; EP 773 112; EP 774 364; EP 849 090, EP 1614538, EP 1614539 EP 1614540 and unpublished European patent applications EP 05105378.3, EP 05109781.4, EP 05109782.2, EP 05108920.9 and unpublished patent application PCT/EP2005/054585.

In a second suitable embodiment, the thermal printing plate precursor comprises a coating comprising an aryldiazosulfonate homo- or copolymer which is hydrophilic and soluble in the processing liquid before exposure to heat or UV light and rendered hydrophobic and less soluble after such exposure.

Preferred examples of such aryldiazosulfonate polymers are the compounds which can be prepared by homo- or copolymerization of aryldiazosulfonate monomers with other aryldiazosulfonate monomers and/or with vinyl monomers such as (meth)acrylic acid or esters thereof, (meth)acrylamide, acrylonitrile, vinylacetate, vinylchloride, vinylidene chloride, styrene, α-methyl styrene etc. Suitable aryldiazosulfonate monomers are disclosed in EP-A 339393, EP-A 507008 and EP-A 771645 and suitable aryldiazosulfonate polymers are disclosed in EP 507,008, EP 960,729, EP 960,730 and EP1,267,211.

A further suitable thermal printing plate is positive working and relies on heat-induced solubilization of an oleophilic resin. The oleophilic resin is preferably a polymer that is soluble in an aqueous developer, more preferably an aqueous alkaline developing solution with a pH between 7.5 and 14. Preferred polymers are phenolic resins e.g. novolac, resoles, polyvinyl phenols and carboxy substituted polymers. Typical examples of these polymers are described in DE-A-4007428, DE-A-4027301 and DE-A-4445820. The amount of phenolic resin present in the first layer is preferably at least 50% by weight, preferably at least 80% by weight relative to the total weight of all the components present in the first layer.

In a preferred embodiment, the oleophilic resin is preferably a phenolic resin wherein the phenyl group or the hydroxy group is chemically modified with an organic substituent. The phenolic resins which are chemically modified with an organic substituent may exhibit an increased chemical resistance against printing chemicals such as fountain solutions or press chemicals such as plate cleaners. Examples of such chemically modified phenolic resins are described in EP-A 0 934 822, EP-A 1 072 432, U.S. Pat. No. 5,641,608, EP-A 0 982 123, WO 99/01795, EP-A 02 102 446, EP-A 02 102 444, EP-A 02 102 445, EP-A 02 102 443, EP-A 03 102 522. The modified resins described in EP-A 02 102 446, are preferred, especially those resins wherein the phenyl-group of said phenolic resin is substituted with a group having the structure —N═N-Q, wherein the —N═N— group is covalently bound to a carbon atom of the phenyl group and wherein Q is an aromatic group.

In the latter embodiment the coating may comprise a second layer that comprises a polymer or copolymer (i.e. (co)polymer) comprising at least one monomeric unit that comprises at least one sulfonamide group. This layer is located between the layer described above comprising the oleophilic resin and the hydrophilic support. Hereinafter, ‘a (co)polymer comprising at least one monomeric unit that comprises at least one sulfonamide group’ is also referred to as “a sulphonamide (co)polymer”. The sulphonamide (co)polymer is preferably alkali soluble. The sulphonamide group is preferably represented by —NR—SO₂—, —SO₂—NR— or —SO₂—NRR′ wherein R and R′ each independently represent hydrogen or an organic substituent.

Sulfonamide (co)polymers are preferably high molecular weight compounds prepared by homopolymerization of monomeric units containing at least one sulfonamide group or by copolymerization of such monomeric units and other polymerizable monomeric units.

Examples of monomeric units containing at least one sulfonamide group include monomeric units further containing at least one polymerizable unsaturated bond such as an acryloyl, allyl or vinyloxy group. Suitable examples are disclosed in U.S. Pat. No. 5,141,838, EP 1545878, EP 909,657, EP 0 894 622 and EP 1,120,246.

Examples of monomeric units copolymerized with the monomeric units containing at least one sulfonamide group include monomeric units as disclosed in EP 1,262,318, EP 1,275,498, EP 909,657, EP 1,120,246,EP 0 894 622 and EP 1,400,351.

Suitable examples of sulfonamide (co)polymers and/or their method of preparation are disclosed in EP-A 933 682, EP-A 982 123, EP-A 1 072 432, WO 99/63407 and EP 1,400,351.

A highly preferred example of a sulfonamide (co)polymer is a homopolymer or copolymer comprising a structural unit represented by the following general formula (I):

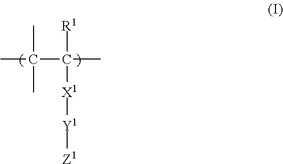

wherein:
R¹ represents hydrogen or a hydrocarbon group having up to 12 carbon atoms; preferably R¹ represents hydrogen or a methyl group;

X¹ represents a single bond or a divalent linking group. The divalent linking group may have up to 20 carbon atoms and may contain at least one atom selected from C, H, N, O and S. Preferred divalent linking groups are a linear alkylene group is having 1 to 18 carbon atoms, a linear, branched, or cyclic group having 3 to 18 carbon atoms, an alkynylene group having 2 to 18 carbon atoms and an arylene group having 6 to 20 atoms, —O—, —S—, —CO—, —CO—O—, —O—CO—, —CS—, —NR^{h}Rⁱ—, —CO—NR^{h}—, —NR^{h}—CO—, —NR^{h}—CO—O—, —O—CO—NR^{h}—, —NR^{h}—CO—NRⁱ—, —NR^{h}—CS—NRⁱ—, a phenylene group, a naphtalene group, an anthracene group, a heterocyclic group, or combinations thereof, wherein R^{h} and Rⁱ each independently represent hydrogen or an optionally substituted alkyl, alkenyl, alkynyl, cycloalkyl, heterocyclic, aryl, heteroaryl, aralkyl or heteroaralkyl group. Preferred substituents on the latter groups are an alkoxy group having up to 12 carbon atoms, a halogen or a hydroxyl group. Preferably X¹ is a methylene group, an ethylene group, a propylene group, a butylene group, an isopropylene group, cyclohexylene group, a phenylene group, a tolylene group or a biphenylene group;
Y¹ is a bivalent sulphonamide group represented by —NR^{j}—SO₂— or —SO₂—NR^{k}— wherein R^{j} and R^{k} each independently represent hydrogen, an optionally substituted alkyl, alkanoyl, alkenyl, alkynyl, cycloalkyl, heterocyclic, aryl, heteroaryl, aralkyl or heteroaralkyl group or a group of the formula —C(═N)—NH—R², wherein R² represents hydrogen or an optionally substituted alkyl or aryl group;

Z¹ represents a bi-, tri- or quadrivalent linking group or a terminal group. When Z¹ is a bi-, tri- or quadrivalent linking group, the remaining 1 to 3 bonds of Z¹ are linked to Y¹ forming crosslinked structural units.
When Z¹ is a terminal group, it is preferably represented by hydrogen or an optionally substituted linear, branched, or is cyclic alkylene or alkyl group having 1 to 18 carbon atoms such as a methyl group, an ethyl group, a propyl group, an isopropyl group, a butyl group, an isobutyl group, a t-butyl group, a s-butyl group, a pentyl group, a hexyl group, a cyclopentyl group, a cyclohexyl group, an octyl group, an optionally substituted arylene or aryl group having 6 to 20 carbon atoms; an optionally substituted hetero-arylene or heteroaryl group; a linear, branched, or cyclic alkenylene or alkenyl group having 2 to 18 carbon atoms, a linear, branched, or cyclic alkynylene or alkynyl group having 2 to 18 carbon atom or an alkoxy group.
When Z is a bi, tri- or quadrivalent linking group, it is preferably represented by an above mentioned terminal group of which hydrogen atoms in numbers corresponding to the valence are eliminated therefrom.
Examples of preferred substituents optionally present on the groups representing Z¹ are an alkyl group having up to 12 carbon atoms, an alkoxy group having up to 12 carbon atoms, a halogen atom or a hydroxyl group.
The structural unit represented by the general formula (I) has preferably the following groups:
X¹ represents an alkylene, cyclohexylene, phenylene or tolylene group, —O—, —S—, —CO—, —CO—O—, —O—CO—, —CS—, —NR^{h}Rⁱ—, —CO—NR^{h}—, —NR^{h}—CO—, —NR^{h}—CO—O—, —O—CO—NR^{h}—, —NR^{h}—CO—NRⁱ—, —NR^{h}—CS—NRⁱ—, or combinations thereof, and wherein R^{h} and Rⁱ each independently represent hydrogen or an optionally substituted alkyl, alkenyl, alkynyl, cycloalkyl, heterocyclic, aryl, heteroaryl, aralkyl or heteroaralkyl group. Preferred substituents on the latter groups are an alkoxy group having up to 12 carbon atoms, a halogen or a hydroxyl group;
Y¹ is a bivalent sulphonamide group represented by —NR^{j}—SO₂—, —SO₂—NR^{k}— wherein R^{j} and R^{k} each independently represent hydrogen, an optionally substituted alkyl, alkanoyl, alkenyl, alkynyl, cycloalkyl, heterocyclic, aryl, heteroaryl, aralkyl or heteroaralkyl group;
Z¹ is a terminal group represented by hydrogen, an alkyl group such as a methyl group, an ethyl group, a propyl group, an isopropyl group, a butyl group, an isobutyl group, a t-butyl group, a s-butyl group, a pentyl group, a hexyl group, a cyclopentyl group, a cyclohexyl group or an octyl group, a benzyl group, an optionally substituted aryl or heteroaryl group, a naphtyl group, an anthracenyl group, a pyridyl group, an allyl group or a vinyl group.

Specific preferred examples of sulphonamide (co)polymers are polymers comprising N-(p-aminosulfonylphenyl)(meth)acrylamide, N-(m-aminosulfonylphenyl)(meth)acrylamide and/or N-(o-aminosulfonylphenyl)(meth)acrylamide. A particularly preferred sulphonamide (co)polymer is a polymer comprising N-(p-aminosulphonylphenyl)methacrylamide wherein the sulphonamide group comprises an optionally substituted straight, branched, cyclic or heterocyclic alkyl group, an optionally substituted aryl group or an optionally substituted heteroaryl group.

The layer comprising the sulphonamide (co)polymer may further comprise additional hydrophobic binders such as a phenolic resin (e.g. novolac, resoles or polyvinyl phenols), a chemically modified phenolic resin or a polymer containing a carboxyl group, a nitrile group or a maleimide group.

The dissolution behavior of the coating of the latter embodiment in the developer can be fine-tuned by optional solubility regulating components. More particularly, development accelerators and development inhibitors can be used. In the embodiment where the coating comprises more than one layer, these ingredients can be added to the first layer, to the second layer and/or to an optional other layer of the coating.

Development accelerators are compounds which act as dissolution promoters because they are capable of increasing the dissolution rate of the coating. For example, cyclic acid anhydrides, phenols or organic acids can be used in order to improve the aqueous developability. Examples of the cyclic acid anhydride include phthalic anhydride, tetrahydrophthalic anhydride, hexahydrophthalic anhydride, 3,6-endoxy-4-tetrahydro-phthalic anhydride, tetrachlorophthalic anhydride, maleic anhydride, chloromaleic anhydride, alpha-phenylmaleic anhydride, succinic anhydride, and pyromellitic anhydride, as described in U.S. Pat. No. 4,115,128. Examples of the phenols include bisphenol A, p-nitrophenol, p-ethoxyphenol, 2,4,4′-trihydroxybenzophenone, 2,3,4-trihydroxy-benzophenone, 4-hydroxybenzophenone, 4,4′,4″-trihydroxy-triphenylmethane, and 4,4′,3″,4″-tetrahydroxy-3,5,3′,5′-tetramethyltriphenyl-methane, and the like. Examples of the organic acids include sulphonic acids, sulfinic acids, alkylsulfuric acids, phosphonic acids, phosphates, and carboxylic acids, as described in, for example, JP-A Nos. 60-88,942 and 2-96,755. Specific examples of these organic acids include p-toluenesulphonic acid, dodecylbenzenesulphonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, 3,4,5-trimethoxybenzoic acid, 3,4,5-trimethoxycinnamic acid, phthalic acid, terephthalic acid, 4-cyclohexene-1,2-dicarboxylic acid, erucic acid, lauric acid, n-undecanoic acid, and ascorbic acid. The amount of the cyclic acid anhydride, phenol, or organic acid contained in the coating is preferably in the range of 0.05 to 20% by weight, relative to the coating as a whole. Polymeric development accelerators such as phenolic-formaldehyde resins comprising at least 70 mol % meta-cresol as recurring monomeric units are also suitable development accelerators.

In a preferred embodiment, the coating also contains developer resistance means, also called development inhibitors, i.e. one or more ingredients which are capable of delaying the dissolution of the unexposed areas during processing. The dissolution inhibiting effect is preferably reversed by heating, so that the dissolution of the exposed areas is not substantially delayed and a large dissolution differential between exposed and unexposed areas can thereby be obtained. The compounds described in e.g. EP-A 823 327 and WO97/39894 are believed to act as dissolution inhibitors due to interaction, e.g. by hydrogen bridge formation, with the alkali-soluble resin(s) in the coating. Inhibitors of this type typically comprise at least one hydrogen bridge forming group such as nitrogen atoms, onium groups, carbonyl (—CO—), sulfinyl (—SO—) or sulfonyl (—SO₂—) groups and a large hydrophobic moiety such as one or more aromatic rings. Some of the compounds mentioned below, e.g. infrared dyes such as cyanines and contrast dyes such as quaternized triarylmethane dyes can also act as a dissolution inhibitor.

Other suitable inhibitors improve the developer resistance because they delay the penetration of the aqueous alkaline developer into the coating. Such compounds can be present in the first layer and/or, if present, in the second layer as described in e.g. EP-A 950 518, and/or in a development barrier layer on top of said layer, as described in e.g. EP-A 864 420, EP-A 950 517, WO 99/21725 and WO 01/45958. In the latter embodiment, the solubility of the barrier layer in the developer or the penetrability of the barrier layer by the developer can be increased by exposure to heat or infrared light.

Preferred examples of inhibitors which delay the penetration of the aqueous alkaline developer into the coating include the following:
(a) A polymeric material which is insoluble in or impenetrable by the developer, e.g. a hydrophobic or water-repellent polymer or copolymer such as acrylic polymers, polystyrene, styrene-acrylic copolymers, polyesters, polyamides, polyureas, polyurethanes, nitrocellulosics and epoxy resins; or polymers comprising siloxane (silicones) and/or perfluoroalkyl units.
(b) Bifunctional compounds such as surfactants comprising a polar group and a hydrophobic group such as a long chain hydrocarbon group, a poly- or oligosiloxane and/or a perfluorinated hydrocarbon group. A typical example is Megafac F-177, a perfluorinated surfactant available from Dainippon Ink & Chemicals, Inc. A suitable amount of such compounds is between 10 and 100 mg/m², more preferably between 50 and 90 mg/m².
(c) Bifunctional block-copolymers comprising a polar block such as a poly- or oligo(alkylene oxide) and a hydrophobic block such as a long chain hydrocarbon group, a poly- or oligosiloxane and/or a perfluorinated hydrocarbon group. A suitable amount of such compounds is between 0.5 and 25 mg/m², preferably between 0.5 and 15 mg/m² and most preferably between 0.5 and 10 mg/m². A suitable copolymer comprises about 15 to 25 siloxane units and 50 to 70 alkyleneoxide groups. Preferred examples include copolymers comprising phenylmethylsiloxane and/or dimethylsiloxane as well as ethylene oxide and/or propylene oxide, such as Tego Glide 410, Tego Wet 265, Tego Protect 5001 or Silikophen P50/X, all commercially available from Tego Chemie, Essen, Germany. Said poly- or oligosiloxane may be a linear, cyclic or complex cross-linked polymer or copolymer. The term polysiloxane compound shall include any compound which contains more than one siloxane group —Si(R,R′)—O—, wherein R and R′ are optionally substituted alkyl or aryl groups. Preferred siloxanes are phenylalkylsiloxanes and dialkylsiloxanes. The number of siloxane groups in the polymer or oligomer is at least 2, preferably at least 10, more preferably at least 20. It may be less than 100, preferably less than 60.

It is believed that during coating and drying, the above mentioned inhibitor of type (b) and (c) tends to position itself, due to its bifunctional structure, at the interface between the coating and air and thereby forms a separate top layer even when applied as an ingredient of the coating solution of the first and/or of the optional second layer. Simultaneously, the surfactants also act as a spreading agent which improves the coating quality. The separate top layer thus formed seems to be capable of acting as the above mentioned barrier layer which delays the penetration of the developer into the coating.

Alternatively, the inhibitor of type (a) to (c) can be applied in a separate solution, coated on top of the first, optional second and/or other layers of the coating. In that embodiment, it may be advantageous to use a solvent in the separate solution that is not capable of dissolving the ingredients present in the other layers so that a highly concentrated water-repellent or hydrophobic phase is obtained at the top of the coating which is capable of acting as the above mentioned development barrier layer.

In addition, the first or optional second layer and/or other layer may comprise polymers that further improve the run length and/or the chemical resistance of the plate. Examples thereof are polymers comprising imido (—CO—NR—CO—) pendant groups, wherein R is hydrogen, optionally substituted alkyl or optionally substituted aryl, such as the polymers described in EP-A 894 622, EP-A 901 902, EP-A 933 682 and WO 99/63407.

The coating of the heat-sensitive printing plate precursors described above preferably also contains an infrared light absorbing dye or pigment which, in the embodiment where the coating comprises more than one layer, may be present in the first layer, and/or in the second layer, and/or in an optional other layer. Preferred IR absorbing dyes are cyanine dyes, merocyanine dyes, indoaniline dyes, oxonol dyes, pyrilium dyes and squarilium dyes. Examples of suitable IR dyes are described in e.g. EP-As 823327, 978376, 1029667, 1053868, 1093934; WO 97/39894 and 00/29214. Preferred compounds are the following cyanine dyes:

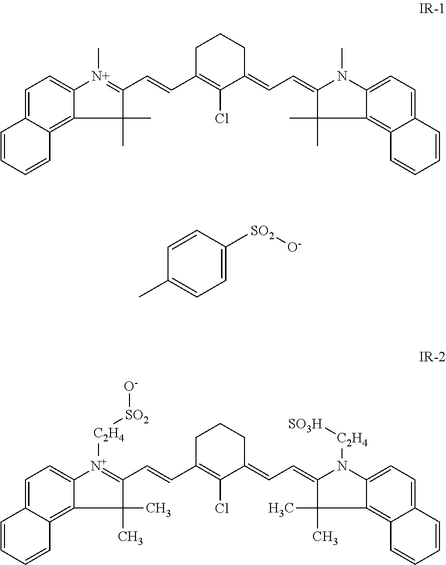

The concentration of the IR-dye in the coating is preferably between 0.25 and 15.0% wt, more preferably between 0.5 and 10.0% wt, most preferably between 1.0 and 7.5 % wt relative to the coating as a whole.

The coating may further comprise one or more colorant(s) such as dyes or pigments which provide a visible color to the coating and which remain in the coating at unexposed areas so that a visible image is obtained after exposure and processing. Such dyes are often called contrast dyes or indicator dyes. Preferably, the dye has a blue color and an absorption maximum in the wavelength range between 600 nm and 750 nm. Although the dye absorbs visible light, it preferably does not sensitize the printing plate precursor, i.e. the coating does not become more soluble in the developer upon exposure to visible light. Typical examples of such contrast dyes are the amino-substituted tri- or diarylmethane dyes, e.g. crystal violet, methyl violet, victoria pure blue, flexoblau 630, basonylblau 640, auramine and malachite green. Also the dyes which are discussed in depth in EP-A 400,706 are suitable contrast dyes. The contrast dye(s) may be present in the first layer, and/or in the optional second and/or other layers.

The heat-sensitive plate precursor can be image-wise exposed directly with heat, e.g. by means of a thermal head, or indirectly by infrared light, preferably near infrared light. The infrared light is preferably converted into heat by an IR light absorbing compound as discussed above. The heat-sensitive lithographic printing plate precursor is preferably not sensitive to visible light, i.e. no substantial effect on the dissolution rate of the coating in the developer is induced by exposure to visible light. Most preferably, the coating is not sensitive to ambient daylight.

The printing plate precursor can be exposed to infrared light by means of e.g. LEDs or a laser. Most preferably, the light used for the exposure is a laser emitting near infrared light having a wavelength in the range from about 750 to about 1500 nm, more preferably 750 to 1100 nm, such as a semiconductor laser diode, a Nd:YAG or a Nd:YLF laser. The required laser power depends on the sensitivity of the plate precursor, the pixel dwell time of the laser beam, which is determined by the spot diameter (typical value of modern plate-setters at 1/e² of maximum intensity: 5-25 μm), the scan speed and the resolution of the exposure apparatus (i.e. the number of addressable pixels per unit of linear distance, often expressed in dots per inch or dpi; typical value: 1000-4000 dpi).

Two types of laser-exposure apparatuses are commonly used: internal (ITD) and external drum (XTD) platesetters. ITD plate-setters for thermal plates are typically characterized by a very high scan speed up to 500 m/sec and may require a laser power of several Watts. XTD plate-setters for thermal plates having a typical laser power from about 200 mW to about 1 W operate at a lower scan speed, e.g. from 0.1 to 10 m/sec. An XTD platesetter equipped with one or more laserdiodes emitting in the wavelength range between 750 and 850 nm is an especially preferred embodiment for the method of the present invention.

The known plate-setters can be used as an off-press exposure apparatus, which offers the benefit of reduced press down-time. XTD plate-setter configurations can also be used for on-press exposure, offering the benefit of immediate registration in a multi-color press. More technical details of on-press exposure apparatuses are described in e.g. U.S. Pat. No. 5,174,205 and U.S. Pat. No. 5,163,368.

After exposure, the precursor can be developed by means of a suitable processing liquid, such as an aqueous alkaline solution, whereby the non-image areas of the coating are removed; the development step may be combined with mechanical rubbing, e.g. by using a rotating brush. During development, any water-soluble protective layer present is also removed. The heat-sensitive printing plate precursors based on latex coalescence, can also be developed using plain water or aqueous solutions, e.g. a gumming solution. The gum solution is typically an aqueous liquid which comprises one or more surface protective compounds that are capable of protecting the lithographic image of a printing plate against contamination or damaging. Suitable examples of such compounds are film-forming hydrophilic polymers or surfactants. The gum solution has preferably a pH from 4 to 10, more preferably from 5 to 8. Preferred gum solutions are described in EP 1,342,568. Alternatively, such printing plate precursors can after exposure directly be mounted on a printing press and be developed on-press by supplying ink and/or fountain to the precursor.

More details concerning the development step can be found in for example EP 1614538, EP 1614539, EP 1614540 and WO/2004071767.

### Light-Sensitive Printing Plate Precursors.

In addition to the above thermal materials, also light-sensitive coatings can be used in the methods of the present invention. Typical examples of such plates are the UV-sensitive “PS” plates and the so-called photopolymer plates which contain a photopolymerizable composition that hardens upon exposure to light.

In a particular embodiment of the present invention, a conventional, UV-sensitive “PS” plate is used. Suitable examples of such plates, that are sensitive in the range of 300-450 nm (near UV and blue light), have been discussed in EP 1,029,668 A2. Positive and negative working compositions are typically used in “PS” plates.

The positive working imaging layer preferably comprises an o-naphtoquinonediazide compound (NQD) and an alkali soluble resin. Particularly preferred are o-naphthoquinone-diazidosulphonic acid esters or o-naphthoquinone diazidocarboxylic acid esters of various hydroxyl compounds and o-naphthoquinone-diazidosulphonic acid amides or o-naphthoquinone-diazidocarboxylic acid amides of various aromatic amine compounds. Two variants of NQD systems can be used: one-component systems and two-component systems. Such light-sensitive printing plates have been widely disclosed in the prior art, for example in U.S. Pat. No. 3,635,709, J. P. KOKAI No. 55-76346, J. P. KOKAI No. Sho 50-117503, J. P. KOKAI No. Sho 50-113305, U.S. Pat. No. 3,859,099; U.S. Pat. No. 3,759,711; GB-A 739654, U.S. Pat. No. 4,266,001 and J. P. KOKAI No. 55-57841.

The negative working layer of a “PS” plate preferably comprises a diazonium salt, a diazonium resin or an aryldiazosulfonate homo- or copolymer. Suitable examples of low-molecular weight diazonium salts include: benzidine tetrazoniumchloride, 3,3′-dimethylbenzidine tetrazoniumchloride, 3,3′-dimethoxybenzidine tetrazoniumchloride, 4,4′-diaminodiphenylamine tetrazoniumchloride, 3,3′-diethylbenzidine tetrazoniumsulfate, 4-aminodiphenylamine diazoniumsulfate, 4-aminodiphenylamine diazoniumchloride, 4-piperidino aniline diazoniumsulfate, 4-diethylamino aniline diazoniumsulfate and oligomeric condensation products of diazodiphenylamine and formaldehyde. Examples of diazo resins include condensation products of an aromatic diazonium salt as the light-sensitive substance. Such condensation products are described, for example, in DE-P-1 214 086. The light- or heat-sensitive layer preferably also contains a binder e.g. polyvinyl alcohol.

Upon exposure the diazo resins or diazonium salts are converted from water soluble to water insoluble (due to the destruction of the diazonium groups) and additionally the photolysis products of the diazo may increase the level of crosslinking of the polymeric binder or diazo resin, thereby selectively converting the coating, in an image pattern, from water soluble to water insoluble. The unexposed areas remain unchanged, i.e. water-soluble.

Such printing plate precursors can be developed using an aqueous alkaline solution as described above.

In a second suitable embodiment, the light sensitive printing plate is based on a photo-polymerisation reaction and contains a coating comprising a photocurable composition comprising a free radical initiator (as disclosed in for example U.S. Pat. No. 5,955,238; U.S. Pat. No. 6,037,098; U.S. Pat. No. 5,629,354; U.S. Pat. No. 6,232,038; U.S. Pat. No. 6,218,076; U.S. Pat. No. 5,955,238; U.S. Pat. No. 6,037,098; U.S. Pat. No. 6,010,824; U.S. Pat. No. 5,629,354; DE 1,470,154; EP 024,629; EP 107,792; U.S. Pat. No. 4,410,621; EP 215,453; DE 3,211,312 and EP A 1,091,247) a polymerizable compound (as disclosed in EP1,161,4541, EP 1349006, WO2005/109103 and unpublished European patent applications EP 5,111,012.0, EP 5,111,025.2, EP 5110918.9 and EP 5,110,961.9) and a polymeric binder (as disclosed in for example US2004/0260050, US2005/0003285; US2005/0123853; EP 1,369,232; EP 1,369,231; EP 1,341,040; US 2003/0124460, EP 1 241 002, EP 1 288 720, U.S. Pat. No. 6,027,857, U.S. Pat. No. 6,171,735; U.S. Pat. No. 6,420,089; EP 152,819; EP 1,043, 627; U.S. Pat. No. 6,899,994; US2004/0260050; US 2005/0003285; US2005/0170286; US2005/0123853; US2004/0260050; US2005/0003285; US 2004/0260050; US 2005/0003285; US 2005/0123853 and US2005/0123853). Other ingredients such as sensitizers, co-initiators, adhesion promoting compounds, colorants, surfactants and/or printing out agents may optionally be added. These printing plates can be sensitized with blue, green or red light (i.e. wavelength range between 450 and 750 nm), with violet light (i.e. wavelength range between 350 and 450 nm) or with infrared light (i.e. wavelength range between 750 and 1500 nm) using for example an Ar laser (488 nm) or a FD-YAG laser (532 nm), semiconductor lasers InGaN (350 to 450 nm), an infrared laser diode (830 nm) or a Nd-YAG laser (1060 nm).

Typically, a photopolymer plate is processed in an aqueous alkaline developer having a pH>10 (see above) and subsequently gummed. Alternatively, the exposed photopolymer plate can also be developed by applying a gum solution to the coating whereby the non-exposed areas are removed. Suitable gumming solutions are described in WO/2005/111727. After the exposure step, the imaged precursor can also be directly mounted on a press and processed on-press by applying ink and/or fountain solution. Methods for preparing such plates are disclosed in WO 93/05446, U.S. Pat. No. 6,027,857, U.S. Pat. No. 6,171,735, U.S. Pat. No. 6,420,089, U.S. Pat. No. 6,071,675, U.S. Pat. No. 6,245,481, U.S. Pat. No. 6,387,595, U.S. Pat. No. 6,482,571, U.S. Pat. No. 6,576,401, U.S. Pat. No. 6,548,222, WO 03/087939, US 2003/16577 and US 2004/13968.

To protect the surface of the coating of the heat and/or light sensitive printing plate precursors, in particular from mechanical damage, a protective layer may also optionally be applied. The protective layer generally comprises at least one water-soluble binder, such as polyvinyl alcohol, polyvinylpyrrolidone, partially hydrolyzed polyvinyl acetates, gelatin, carbohydrates or hydroxyethylcellulose, and can be produced in any known manner such as from an aqueous solution or dispersion which may, if required, contain small amounts—i.e. less than 5% by weight based on the total weight of the coating solvents for the protective layer—of organic solvents. The thickness of the protective layer can suitably be any amount, advantageously up to 5.0 μm, preferably from 0.1 to 3.0 μm, particularly preferably from 0.15 to 1.0 μm.

Optionally, the coating may further contain additional ingredients such as surfactants, especially perfluoro surfactants, silicon or titanium dioxide particles or polymers particles such as matting agents and spacers.

Any coating method can be used for applying two or more coating solutions to the hydrophilic surface of the support. The multi-layer coating can be applied by coating/drying each layer consecutively or by the simultaneous coating of several coating solutions at once. In the drying step, the volatile solvents are removed from the coating until the coating is self-supporting and dry to the touch. However it is not necessary (and may not even be possible) to remove all the solvent in the drying step. Indeed the residual solvent content may be regarded as an additional composition variable by means of which the composition may be optimized. Drying is typically carried out by blowing hot air onto the coating, typically at a temperature of at least 70° C., suitably 80-150° C. and especially 90-140° C. Also infrared lamps can be used. The drying time may typically be 15-600 seconds.

Between coating and drying, or after the drying step, a heat treatment and subsequent cooling may provide additional benefits, as described in WO99/21715, EP-A 1074386, EP-A 1074889, WO00/29214, and WO/04030923, WO/04030924, WO/04030925.

The printing plates thus obtained can be used for conventional, so-called wet offset printing, in which ink and an aqueous dampening liquid are supplied to the plate. Another suitable printing method uses so-called single-fluid ink without a dampening liquid. Suitable single-fluid inks have is been described in U.S. Pat. No. 4,045,232; U.S. Pat. No. 4,981,517 and U.S. Pat. No. 6,140,392. In a most preferred embodiment, the single-fluid ink comprises an ink phase, also called the hydrophobic or oleophilic phase, and a polyol phase as described in WO 00/32705.

The coatings described herein can also be used as a thermo-resist for forming a pattern on a substrate by direct imaging techniques, e.g. in a PCB (printed circuit board) application as described in US 2003/0003406 A1.

### Examples

### Example 1

Preparation of the Lithographic Substrates AS 01-17.

1. First Graining Step.

A 0.30 mm thick aluminium support (AA 1050) was degreased by dipping it in an aqueous solution containing 34 g/l NaOH at 75° C. for 5 seconds (without moving the foil or stirring the solution) and rinsed for 5 seconds with demineralised water at room temperature (while continuously moving the foil). The support was then electrochemically grained using an alternating current with a density of 120 A/dm² in an aqueous solution containing 12.5 g/l HCl at a temperature of 37° C., resulting in a total charge density of x C/dm² (see Table 1). Before graining the foil was pre-etched for 3 seconds in the graining electrolyte.

2. Desmutting Step.

After this first graining step the support was desmutted by dipping it in an aqueous solution containing 145 g/l H₂SO₄ at 75° C. for 4 seconds.

3. Surface Morphology Characterisation.

For the purpose of an intermediate surface morphology characterization, part of this support was subsequently rinsed for 5 seconds in demineralised water at room temperature (while continuously moving the foil) and subsequently desmutted by dipping it in an aqueous solution containing 6.5 g/l NaOH at 35° C. for 5 seconds. Based on the information obtained from image analysis of interferometer images of the substrates obtained using an interferometer NT3300 (commercially available from Veeco Metology Group, Arizona, USA), a computer program, for example MatLAb code, calculates the mean values of the depth and area of the pits present on the surface after the first graining step. The results are summarized in Table 1.

4. Second Graining Step.

The rest of the support was submitted to a second graining step, using the same graining conditions as used in the first graining step (see Example 1, point 1 above: graining electrolyte, graining current) resulting in a total charge density of y C/dm². The total charge density over the whole graining process amounted to 900 C/dm².

TABLE 1
graining conditions and surface morphology
parameters.

| | First graining step | | | | Second graining | |
|---|---|---|---|---|---|---|
| | | | | Mean | step | |
| | | Charge | | pit | | Charge |
| | | density x | Ra | depth | | density y |
| Support | Durations | C/dm² | μm | μm | Durations | C/dm² |
| A | 0.83 | 100 | 0.21 | 0.49 | 6.67 | 800 |
| B | 1.67 | 200 | 0.25 | 0.54 | 5.83 | 700 |
| C | 2.50 | 300 | 0.23 | 0.59 | 5.00 | 600 |
| D | 3.33 | 400 | 0.27 | 0.87 | 4.17 | 500 |
| E | 4.17 | 500 | 0.36 | 1.20 | 3.33 | 400 |
| F | 5.00 | 600 | 0.43 | 1.42 | 2.50 | 300 |
| G | 5.83 | 700 | 0.46 | 1.59 | 1.67 | 200 |
| H | 6.67 | 800 | 0.54 | 1.79 | 0.83 | 100 |
| I | 7.50 | 900 | 0.50 | 1.84 | 0 | 0 |

5. Final Desmutting Step.

The obtained supports A-I were then subjected to a final desmutting step by dipping them in an aqueous solution containing 145 g/l H₂SO₄ at 80° C. for respectively 2 seconds (resulting in aluminium substrates AS-01 to 09) and 6 seconds (aluminium substrates AS-10 to 17). Finally they were rinsed for 5 seconds in demineralised water at room temperature (while continuously moving the foil).

### Determination of Pit Depth and Pit Area of the Lithographic Supports AS-01 to AS-17.

Based on the information obtained from image analysis of interferometer images of the substrates obtained using an interferometer NT3300 (commercially available from Veeco Metology Group, Arizona, USA), a computer program, for example MatLAb code, calculates the mean values of the depth and area of the pits present on the surface of the grained aluminum supports AS-01-AS-17. The results are summarized in Table 2 (lithographic supports AS-01 to AS-09 with a final desmut step of 2 s) and Table 3 (lithographic supports AS-10 to AS-17 with a final desmut step of 6 s).

TABLE 2
pit depth and pit area of the lithographic
supports AS-01 to AS-09.

| | | | Mean | Variation | Mean | Variation |
|---|---|---|---|---|---|---|
| | | | pit | in pit | pit | in pit |
| | Aluminium | Ra | depth | depth* | area | area* |
| Support | substrate | μm | μm | μm | μm² | μm² |
| A | AS-01 | 0.46 | 1.97 | 0.40 | 20.51 | 32.88 |
| | Comp. Ex. | | | | | |
| B | AS-02 | 0.48 | 1.70 | 0.38 | 22.35 | 33.89 |
| | Comp. Ex. | | | | | |
| C | AS-03 | 0.41 | 1.46 | 0.27 | 14.58 | 20.86 |
| | Inv. Ex. | | | | | |
| D | AS-04 | 0.42 | 1.50 | 0.33 | 16.71 | 24.30 |
| | Inv. Ex. | | | | | |
| E | AS-05 | 0.44 | 1.50 | 0.33 | 16.82 | 21.39 |
| | Inv. Ex. | | | | | |
| F | AS-06 | 0.40 | 1.49 | 0.35 | 16.67 | 21.90 |
| | Inv. Ex. | | | | | |
| G | AS-07 | 0.47 | 1.74 | 0.37 | 18.15 | 25.42 |
| | Comp. Ex. | | | | | |
| H | AS-08 | 0.52 | 2.04 | 0.37 | 18.05 | 26.17 |
| | Comp. Ex. | | | | | |
| I | AS-09 | 0.54 | 2.08 | 0.45 | 24.37 | 32.57 |
| | Comp. Ex. | | | | | |

*Variation in pit depth and pit area is determined by the standard deviation between the various measurements of the pits.

TABLE 3
pit depth and pit area of the lithographic
supports AS-10 to AS-17.

| | | | Mean | Variation | Mean | Variation |
|---|---|---|---|---|---|---|
| | | | pit | in pit | pit | in pit |
| | Aluminium | Ra | depth | depth* | area | area* |
| Support | substrate | μm | μm | μm | μm² | μm² |
| B | AS-10 | 0.47 | 1.64 | 0.38 | 24.74 | 35.00 |
| | Comp. Ex. | | | | | |
| C | AS-11 | 0.41 | 1.53 | 0.28 | 13.41 | 18.23 |
| | Inv. Ex. | | | | | |
| D | AS-12 | 0.44 | 1.57 | 0.35 | 19.19 | 26.89 |
| | Inv. Ex. | | | | | |
| E | AS-13 | 0.43 | 1.57 | 0.31 | 16.31 | 21.41 |
| | Inv. Ex. | | | | | |
| F | AS-14 | 0.40 | 1.46 | 0.35 | 16.88 | 23.41 |
| | Inv. Ex. | | | | | |
| G | AS-15 | 0.47 | 1.72 | 0.39 | 20.72 | 29.25 |
| | Comp. Ex. | | | | | |
| H | AS-16 | 0.54 | 2.02 | 0.42 | 20.99 | 29.32 |
| | Comp. Ex. | | | | | |
| I | AS-17 | 0.59 | 2.15 | 0.52 | 29.26 | 47.74 |
| | Comp. Ex. | | | | | |

*Variation in pit depth and pit area is determined by the standard deviation between the various measurements of the pits.

From the analysis of these results, it is clear that the aluminium substrates AS-03 to AS-06, and AS-11 to AS-14 where the applied graining charges x and y satisfy the equation where x/x+y varies between 0.3 and 0.7, results in substrate with a mean pit depth equal to or lower than 1.6 μm and a standard deviation of these mean pit depth which is equal to or lower than 0.35 μm. These results indicate that the pits obtained on the surface of the supports prepared according to the present invention, have small pits which are uniform in size. Also the mean pit area values are smaller as well as the standard deviation values of these areas.

### Example 2

### Preparation of the Lithographic Substrates AS 18-35.

1. First Graining Step.

A 0.30 mm thick aluminium support (AA 1050) was degreased by dipping it in an aqueous solution containing 34 g/l NaOH at 75° C. for 5 seconds (without moving the support or stirring the solution) and rinsed for 5 seconds with demineralised water at room temperature (while continuously moving the support). The support was then electrochemically grained using an alternating current with a density of 180 A/dm² (simulating the conditions at a higher line speed in production=higher current density+shorter dwell time) in an aqueous solution containing 12.5 g/l HCl at a temperature of 37° C., resulting in a total charge density of x C/dm² (Table 4). Before graining the support was pre-etched for 3 seconds in the graining electrolyte.

2. Desmutting Step.

After the first graining step the support was desmutted by dipping it in an aqueous solution containing 145 g/l H₂SO4 at 75° C. for 4 seconds.

3. Surface Morphology Characterisation.

For the purpose of an intermediate surface morphology characterization, part of this support was subsequently rinsed for 5 seconds in demineralised water at room temperature (while continuously moving the support) and subsequently desmutted by dipping it in an aqueous solution containing 6.5 g/l NaOH at 35° C. for 5 seconds. Based on the information obtained from image analysis of interferometer images of the substrates obtained using an interferometer NT3300 (commercially available from Veeco Metology Group, Arizona, USA), a computer program, for example MatLAb code, calculates the mean values of the depth and area of the pits present on the surface after the first graining step. The results are summarized in Table 4.

4. Second Graining Step.

The rest of the support was submitted to a second graining step, using the same graining conditions as in the first graining step (see Example 2, point 1 above: graining electrolyte, graining current) resulting in a total charge density of y C/dm². The total charge density over the whole graining process amounted to 900 C/dm².

TABLE 4
graining conditions and surface morphology
parameters.

| | First graining step | | | | Second graining | |
|---|---|---|---|---|---|---|
| | | | | Mean | step | |
| | | Charge | | pit | | Charge |
| | | density x | Ra | depth | | density y |
| Support | Durations | C/dm² | μm | μm | Durations | C/dm² |
| J | 0.56 | 100 | 0.22 | 0.42 | 4.44 | 800 |
| K | 1.11 | 200 | 0.21 | 0.47 | 3.89 | 700 |
| L | 1.67 | 300 | 0.22 | 0.66 | 3.33 | 600 |
| M | 2.22 | 400 | 0.26 | 0.73 | 2.78 | 500 |
| N | 2.78 | 500 | 0.32 | 1.13 | 2.22 | 400 |
| O | 3.33 | 600 | 0.40 | 1.33 | 1.67 | 300 |
| P | 3.89 | 700 | 0.50 | 1.79 | 1.11 | 200 |
| Q | 4.44 | 800 | 0.58 | 1.95 | 0.56 | 100 |
| R | 5.00 | 900 | 0.64 | 2.21 | 0 | 0 |

5. Final Desmutting Step.

The obtained supports J-R were then subjected to a final desmutting step by dipping them in an aqueous solution containing 145 g/l H₂SO₄ at 80° C. for respectively 2 seconds (Table 5, aluminium substrates AS-18 to 26) and 6 seconds (Table 6, aluminium substrates AS-27 to 35). Finally the supports were rinsed for 5 seconds in demineralised water at room temperature (while continuously moving the support).

### Determination of Pit Depth and Pit Area of the Lithographic Supports AS-18 to AS-35.

Based on the information obtained from image analysis of interferometer images of the substrates obtained using an interferometer NT3300 (commercially available from Veeco Metology Group, Arizona, USA), a computer program, for example MatLAb code, calculates the mean values of the depth and area of the pits present on the surface of the grained aluminum supports AS-18-AS-35. The results are summarized in Table 5 (lithographic supports AS-18 to AS-26 with a final desmut step of 2 s) and Table 6 (lithographic supports AS-27 to AS-35 with a final desmut step of 6 s).

TABLE 5
pit depth and pit area of the lithographic
supports AS-18 to AS-26.

| | | | Mean | Variation | | Variation |
|---|---|---|---|---|---|---|
| | | | pit | in pit | Mean pit | in pit |
| | Aluminium | Ra | depth | depth* | area | area* |
| Support | substrate | μm | μm | μm | μm² | μm² |
| J | AS-18 | 0.52 | 2.02 | 0.54 | 22.27 | 28.60 |
| | Comp. Ex. | | | | | |
| K | AS-19 | 0.47 | 1.70 | 0.50 | 24.44 | 29.60 |
| | Comp. Ex. | | | | | |
| L | AS-20 | 0.42 | 1.46 | 0.41 | 19.83 | 25.28 |
| | Inv. Ex. | | | | | |
| M | AS-21 | 0.39 | 1.42 | 0.31 | 15.41 | 20.85 |
| | Inv. Ex. | | | | | |
| N | AS-22 | 0.40 | 1.43 | 0.25 | 12.36 | 16.44 |
| | Inv. Ex. | | | | | |
| O | AS-23 | 0.41 | 1.45 | 0.40 | 20.78 | 28.62 |
| | Inv. Ex. | | | | | |
| P | AS-24 | 0.46 | 1.66 | 0.54 | 24.93 | 32.23 |
| | Comp. Ex. | | | | | |
| Q | AS-25 | 0.55 | 2.05 | 0.65 | 33.63 | 41.93 |
| | Comp. Ex. | | | | | |
| R | AS-26 | 0.65 | 2.31 | 0.73 | 37.57 | 53.28 |
| | Comp. Ex. | | | | | |

*Variation in pit depth and pit area is determined by the standard deviation between the various measurements of the pits.

TABLE 6
pit depth and pit area of the lithographic
supports AS-27 to AS-35.

| | | | Mean | Variation | | Variation |
|---|---|---|---|---|---|---|
| | | | pit | in pit | Mean pit | in pit |
| | Aluminium | Ra | depth | depth* | area | area* |
| Support | substrate | μm | μm | μm | μm² | μm² |
| J | AS-27 | 0.55 | 2.02 | 0.50 | 24.21 | 30.97 |
| | Comp. Ex. | | | | | |
| K | AS-28 | 0.50 | 1.71 | 0.58 | 28.57 | 37.12 |
| | Comp. Ex. | | | | | |
| L | AS-29 | 0.41 | 1.46 | 0.40 | 19.24 | 24.68 |
| | Inv. Ex. | | | | | |
| M | AS-30 | 0.37 | 1.38 | 0.29 | 14.38 | 16.39 |
| | Inv. Ex. | | | | | |
| N | AS-31 | 0.36 | 1.36 | 0.27 | 13.66 | 22.08 |
| | Inv. Ex. | | | | | |
| O | AS-32 | 0.41 | 1.47 | 0.45 | 21.44 | 30.90 |
| | Inv. Ex. | | | | | |
| P | AS-33 | 0.49 | 1.71 | 0.57 | 26.77 | 38.47 |
| | Comp. Ex. | | | | | |
| Q | AS-34 | 0.57 | 1.96 | 0.67 | 36.70 | 47.91 |
| | Comp. Ex. | | | | | |
| R | AS-35 | 0.62 | 2.15 | 0.77 | 41.64 | 59.09 |
| | Comp. Ex. | | | | | |

*Variation in pit depth and pit area is determined by the standard deviation between the various measurements of the pits.

From the analysis of these results, it is clear that the aluminium substrates AS-20 to AS-23, and AS-29 to AS-32 where the graining charges x and y satisfy the equation where x/x+y so varies between 0.3 and 0.7, results in substrate with a mean pit depth equal to or lower than 1.6 μm and a standard deviation of these mean pit depth which is equal to or lower than 0.45 μm. These results indicate that the pits obtained on the surface of the supports prepared according to the present invention, have small pits which are uniform in size. Also the mean pit area values are significantly smaller as well as their standard deviation values.

### Example 3

Similar results for mean pit depth and mean pit depth standard deviation were obtained for aluminum substrates which were prepared as in Examples 1 and 2 (first graining step, desmut step and second graining step) but which were dipped in an aqueous solution containing 6.5 g/l NaOH at 35° C. for 5 seconds as final desmut step. Even when the final desmut step was omitted, similar results were obtained.

1-10. (canceled)

11. A method for making a lithographic aluminum printing plate support comprising the steps of
(i) graining said support by applying a charge density x;
(ii) desmutting the grained support; and
(iii) graining the treated support by applying a charge density y;
wherein during each graining step a current density ranging between 80 and 250 A/dm² is applied and the ratio x/x+y ranges between 0.3 and 0.7.

12. A method according to claim 11, wherein during each graining step the current density ranges between 90 and 220 A/dm².

13. A method according to claim 11, wherein each graining step is carried out in an aqueous solution comprising hydrochloric acid.

14. A method according to claim 12, wherein each graining step is carried out in an aqueous solution comprising hydrochloric acid.

15. A method according to claim 11, wherein during each graining step the charge density x ranges between 100 and 1500 C/dm².

16. A method according to claim 12, wherein during each graining step the charge density x ranges between 100 and 1500 C/dm².

17. A method according to claim 11, wherein during each graining step the charge density x ranges between 150 and 1250 C/dm².

18. A method according to claim 12, wherein during each graining step the charge density x ranges between 150 and 1250 C/dm².

19. A method according to claim 11, wherein the desmutting step is carried out by contacting the support with an aqueous acidic solution for a period ranging between 1 and 15 s.

20. A method according to claim 11, wherein the desmutting step is carried out by contacting the support with an aqueous acidic solution for a period ranging between 1.5 and 13 s.

21. A method according to claim 11, wherein the desmutting step is carried out by contacting the support with an aqueous acidic solution for a period ranging between 2 and 10 s.

22. A method according to claim 12, wherein the desmutting step is carried out by contacting the support with an aqueous acidic solution for a period ranging between 1 and 15 s.

23. A method according to claim 13, wherein the desmutting step is carried out by contacting the support with an aqueous acidic solution for a period ranging between 1 and 15 s.

24. A method according to claim 15, wherein the desmutting step is carried out by contacting the support with an aqueous acidic solution for a period ranging between 1 and 15 s.

25. A method for making a lithographic printing plate precursor comprising the steps of:
(i) providing a support according to the method of claim 1;
(ii) applying a coating comprising at least one heat- or light-sensitive imaging layer onto said support; and
(iii) drying the coated support provided in step (ii) to obtain the precursor.

26. A method for making a lithographic printing plate precursor comprising the steps of:
(i) providing a support according to the method of claim 1;
(ii) applying onto said support a coating comprising an infrared absorbing agent, a first heat-sensitive imaging layer comprising a heat-sensitive oleophilic resin and a second heat-sensitive imaging layer located between said first layer and the hydrophilic support which comprises a polymer comprising at least one monomeric unit that comprises at least one sulphonamide group; and
(iii) drying the coated support provided in step (ii) to obtain the precursor.

27. A method for making a lithographic printing plate precursor comprising the steps of:
(i) providing a support according to the method of claim 1;
(ii) applying a coating comprising an imaging layer onto said support, the imaging layer comprising an infrared absorbing agent, hydrophobic thermoplastic polymer particles and a hydrophilic binder; and
(iii) drying the coated support provided in step (ii) to obtain the precursor.
